(19) United States
(12) Patent Application Publication
(10) Pub. No.: US 2023/0023690 A1
(43) Pub. Date: Jan. 26, 2023

(54) CHARGING STATION FOR ELECTRIC PASSENGER VEHICLES

(71) Applicant: Indiev, Inc, Los Angeles, CA (US)

(72) Inventors: Andre Hudson, Los Angeles, CA (US); Young Joon Ju, Los Angeles, CA (US)

(21) Appl. No.: 17/381,628

(22) Filed: Jul. 21, 2021

(51) Int. Cl. B60L 53/30; B60L 53/12

(52) U.S. Cl. CPC B60L 53/30; B60L 53/12

(57) ABSTRACT

Charging stations for electric passenger vehicles are provided. A charging station can have two levels to accommodate passenger vehicles, with multiple spaces on each level. At least one of the spaces can be a charging platform that can charge an electric passenger vehicle located thereon. The charging station can be mobile, for example, by having its main body structure be sized such that it can be transported via a tractor trailer or other large transport vehicle.

### BACKGROUND

Electric passenger vehicles are becoming more prevalent, leading to a need for more places to charge such vehicles. Such charging places are generally parking spaces with a charging cord connected to a tower or similar structure, and the driver of the vehicle parks in the parking space and plugs the charging cord into the vehicle. These charging places are static and can lead to inconveniences if multiple drivers are attempting to charge their respective vehicles at the same time.

### BRIEF SUMMARY

Embodiments of the subject invention provide novel and advantageous charging stations for electric passenger vehicles, as well as methods of using the same. A charging station can have two levels to accommodate passenger vehicles, with multiple spaces (that can also be referred to as positions, platforms, or pads) on each level. At least one of the spaces can be a charging platform that can charge an electric passenger vehicle located thereon. Each charging platform can be a wireless charging platform or can be a wired charging platform. The charging station can be mobile, for example, by having its main body structure be sized such that it can be transported via a tractor trailer or other large transport vehicle (i.e., it can be sized such that it would fit on a standard tractor trailer bed (see, e.g., FIG. 6). The charging station can be sized such that it fits within current gas station fill-up bays, allowing it to replace the use of space for traditional gas refueling. The spaces or platforms can revolve on a carousel system to allow passenger vehicles to move around within the charging station (e.g., to enter while one or more passenger vehicles are already charging, and to exit after charging is complete even if one or more other passenger vehicles are present on the charging station).

In an embodiment, a charging station for charging electric passenger vehicles can comprise: a main body structure comprising a first side wall and a second side wall spaced apart from the first side wall, the main body structure comprising a lower level and an upper level; a first platform disposed between the first side wall and the second side wall and configured to support a first electric passenger vehicle parked thereon and to charge the first electric passenger vehicle; a second platform disposed between the first side wall and the second side wall and configured to support a second electric passenger vehicle parked thereon; and a third platform disposed between the first side wall and the second side wall and configured to support a third electric passenger vehicle parked thereon. The charging station can be configured such that each of the first platform, the second platform, and the third platform is movable from the upper level to the lower level and back. The first platform can be configured to wirelessly charge the first electric passenger vehicle while the first electric passenger vehicle is parked on the first platform. The second platform can be configured to wirelessly charge the second electric passenger vehicle while the second electric passenger vehicle is parked on the second platform, and/or the third platform can be configured to wirelessly charge the third electric passenger vehicle while the third electric passenger vehicle is parked on the third platform. The charging station can further comprise a fourth platform disposed between the first side wall and the second side wall and configured to support a fourth electric passenger vehicle parked thereon, and the charging station can be configured such that the fourth platform is movable from the upper level to the lower level and back. The fourth platform can be configured to wirelessly charge the fourth electric passenger vehicle while the fourth electric passenger vehicle is parked on the fourth platform. A height of the lower level can be in a range of, for example, from 7 feet to 8.5 feet. A width of the charging station can be in a range of, for example, from 7 feet to 10 feet. A length of the charging station can be in a range of, for example, from 35 feet to 75 feet (e.g., from 35 feet to 40 feet). The charging station can be mobile. The charging station can be configured such that each of the first platform, the second platform, and the third platform is independently movable fore and aft within the lower level (e.g., by using a rail on the lower level), and the charging station can be configured such that each of the first platform, the second platform, and the third platform is independently movable from the upper level to the lower level and back (e.g., by using a cable lift system). The charging station can further comprise a semi-enclosed or fully enclosed structure disposed on one of the second platform and the third platform and being configured to provide rest, services, or both to a driver of an electric passenger vehicle being charged on the charging station. Each of the first side wall and the second side wall can have a longer length at the lower level than it does at the upper level.

In a further embodiment, the charging station can further comprise a fourth platform disposed between the first side wall and the second side wall and configured to support a fourth electric passenger vehicle parked thereon, wherein the charging station is configured such that the fourth platform is movable from the upper level to the lower level and back, wherein the fourth platform is configured to wirelessly charge the fourth electric passenger vehicle while the fourth electric passenger vehicle is parked on the fourth platform, and wherein the charging station is configured to rotate in a carousel style each of the first platform, the second platform, the third platform, and the fourth platform around the main body structure (e.g., by using a cable system), such that when one platform of the first platform, the second platform, the third platform, and the fourth platform is lowered from the upper level to the lower level at a proximal end of the main body structure, another platform of the first platform, the second platform, the third platform, and the fourth platform is simultaneously raised from the lower level to the upper level at a distal end of the main body structure opposite from the proximal end. The charging station can further comprise: a fifth platform disposed between the first side wall and the second side wall and configured to support a fifth electric passenger vehicle parked thereon; and a sixth platform disposed between the first side wall and the second side wall and configured to support a sixth electric passenger vehicle parked thereon, wherein the fifth platform is configured to wirelessly charge the fifth electric passenger vehicle while the fifth electric passenger vehicle is parked on the fifth platform, wherein the charging station is configured such that the sixth platform is movable from the upper level to the lower level and back, wherein the sixth platform is configured to wirelessly charge the sixth electric passenger vehicle while the sixth electric passenger vehicle is parked on the sixth platform, and wherein the charging station is configured to rotate in a carousel style each of the first platform, the second platform, the third platform, the fourth platform, the fifth platform, and the sixth platform around the main body structure (e.g., by using a cable system), such that when one platform of the first platform, the second platform, the third platform, the fourth platform, the fifth platform, and the sixth platform is lowered from the upper level to the lower level at a proximal end of the main body structure, another platform of the first platform, the second platform, the third platform, the fourth platform, the fifth platform, and the sixth platform is simultaneously raised from the lower level to the upper level at a distal end of the main body structure opposite from the proximal end.

### BRIEF DESCRIPTION OF DRAWINGS

FIG. 1 shows a perspective view of a charging station, according to an embodiment of the subject invention.

FIG. 2 shows a perspective view of a charging station, according to an embodiment of the subject invention. FIG. 2 shows how the concept can be extended to longer charging stations by adding additional spaces.

FIG. 3A shows a perspective view of a charging station, according to an embodiment of the subject invention, with four spaces for passenger vehicles.

FIG. 3B shows a perspective view of a charging station, according to an embodiment of the subject invention, with six spaces for passenger vehicles.

FIG. 3C shows a perspective view of a charging station, according to an embodiment of the subject invention, with eight spaces for passenger vehicles.

FIG. 4A shows a perspective view of a charging station, according to an embodiment of the subject invention, with four spaces for passenger vehicles, as well as an indication that a charging station of this size may be used with a small gas station.

FIG. 4B shows a perspective view of a charging station, according to an embodiment of the subject invention, with six spaces for passenger vehicles, as well as an indication that a charging station of this size may be used with a medium gas station.

FIG. 4C shows a perspective view of a charging station, according to an embodiment of the subject invention, with eight spaces for passenger vehicles, as well as an indication that a charging station of this size may be used with a large gas station.

FIG. 5 shows a perspective view of a charging station, according to an embodiment of the subject invention, with example dimensions of the width, length, and height of the charging station. The dimensions given in FIG. 5 are for exemplary purposes only and should not be construed as limiting.

FIG. 6 shows a side view of a large truck with a charging station of an embodiment of the subject invention being towed thereby. The right-hand side of FIG. 6 indicates that the truck can transport the charging station to, for example, a gas station, a parking lot, and/or a public and/or private space.

FIG. 7 shows a perspective view of a charging station, according to an embodiment of the subject invention.

FIG. 8 shows a perspective view of a charging station, according to an embodiment of the subject invention.

FIG. 9 shows a perspective view of the charging station of FIGS. 7 and 8, illustrating how a passenger vehicle may be tracked on the lower level and a passenger vehicle may be lowered from the upper level (e.g., after charging) to thereby exit the charging station.

FIG. 10 shows a perspective view of the charging station of FIGS. 7 and 8, illustrating how a passenger vehicle may be tracked on the lower level and a passenger vehicle may be lowered from the upper level (e.g., after charging) to thereby exit the charging station.

FIG. 11 shows a perspective view of a charging station, according to an embodiment of the subject invention, in which the lower level may include a space for rest and/or services in one of the lower level spaces (instead of a space for a passenger vehicle).

FIG. 12 shows a perspective view of a charging station, according to an embodiment of the subject invention, in which the spaces or positions can be rotated around the body structure.

FIG. 13 shows a perspective view of a charging station, according to an embodiment of the subject invention, in which the spaces or positions can be rotated around the body structure.

FIG. 14 shows a perspective view of the charging station of FIGS. 12 and 13, illustrating how the spaces or positions may be rotated even as they are occupied by passenger vehicles, to allow a passenger vehicle from the upper level to be lowered (e.g., after charging) to thereby exit the charging station.

FIG. 15 shows a perspective view of the charging station of FIGS. 12 and 13, illustrating how the spaces or positions may be rotated even as they are occupied by passenger vehicles, to allow a passenger vehicle from the upper level to be lowered (e.g., after charging) to thereby exit the charging station.

### DETAILED DESCRIPTION

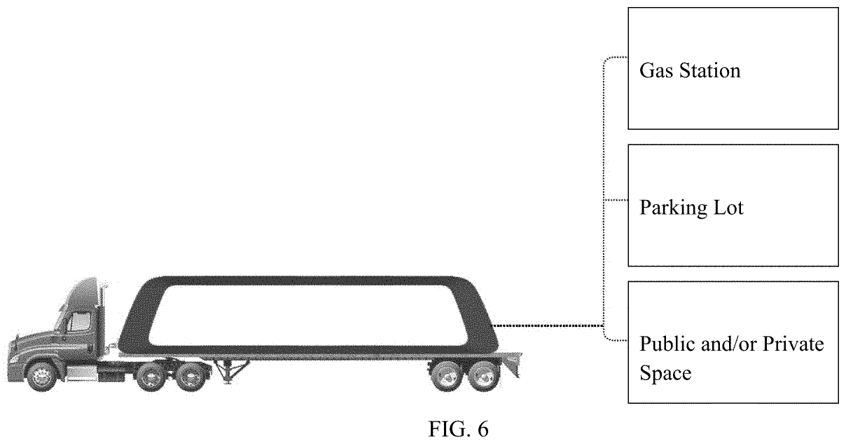

Embodiments of the subject invention provide novel and advantageous charging stations for electric passenger vehicles, as well as methods of using the same. A charging station can have two levels to accommodate passenger vehicles, with multiple spaces (that can also be referred to as positions, platforms, or pads) on each level. At least one of the spaces can be a charging platform that can charge an electric passenger vehicle located thereon. Each charging platform can be a wireless charging platform or can be a wired charging platform. The charging station can be mobile, for example, by having its main body structure be sized such that it can be transported via a tractor trailer or other large transport vehicle (i.e., it can be sized such that it would fit on a standard tractor trailer bed (see, e.g., FIG. 6). The charging station can be sized such that it fits within current gas station fill-up bays, allowing it to replace the use of space for traditional gas refueling. The spaces or platforms can revolve on a carousel system to allow passenger vehicles to move around within the charging station (e.g., to enter while one or more passenger vehicles are already charging, and to exit after charging is complete even if one or more other passenger vehicles are present on the charging station).

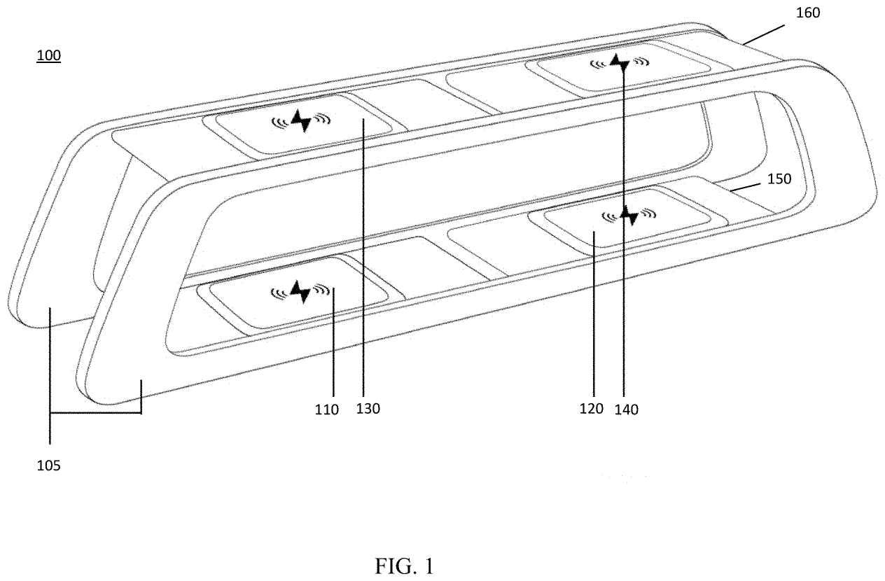

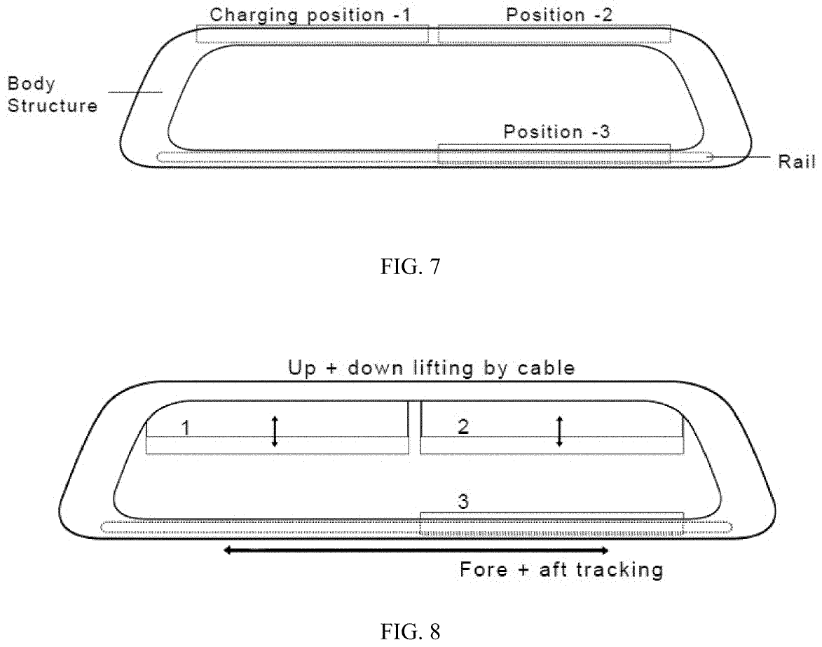

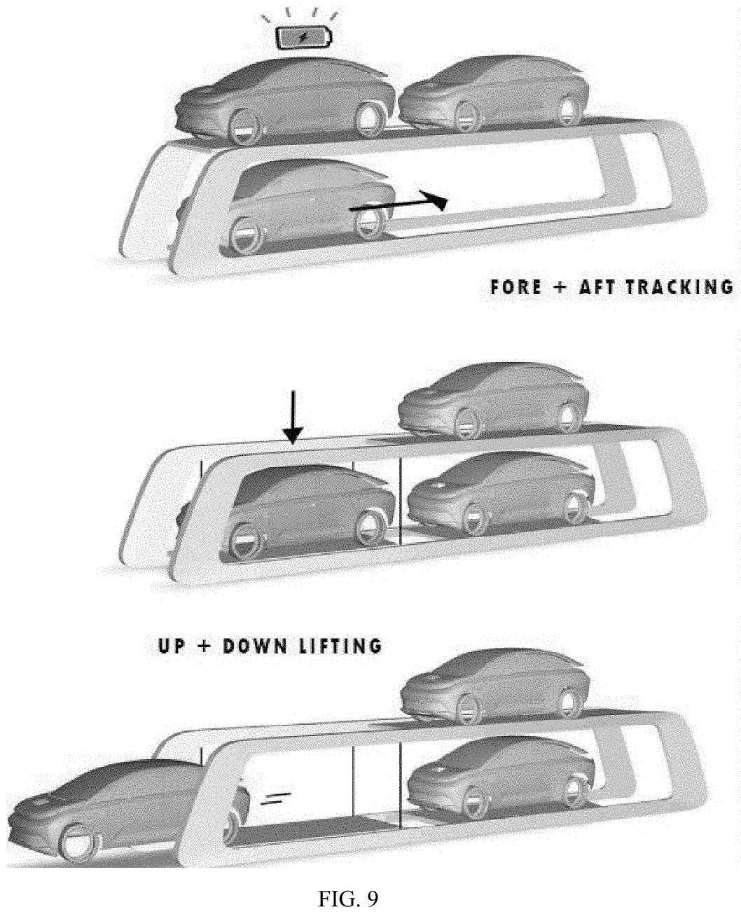

FIG. 1 shows a perspective view of a charging station, according to an embodiment of the subject invention. Referring to FIG. 1, a charging station 100 can include a main body structure 105 having a lower level 150 and an upper level 160. The lower level 150 can include at least two spaces or platforms 110,120, and the upper level 160 can include at least two spaces or platforms 130,140. Although platforms are referred to as upper level platforms or lower level platforms, this is for convenience to describe the positions as depicted in the figures; it should be understood that the platforms can move from upper level to lower level and back (see, e.g., FIGS. 7-10).

The height of the lower level 150 (the distance between the upper surface of the lower level spaces 110,120 and the lower surface of the upper level platforms 130,140) is sufficient such that an electric passenger vehicle can fit in the lower level. For example, the height of the lower level 150 can be at least 6 feet, at least 6.5 feet, at least 7 feet, at least 7.5 feet, at least 8 feet, at least 8 feet and 4 inches, at least 8.5 feet, or at least 9 feet. The height can also be low enough such that the overall charging station 100 size is suitable for transport on a tractor trailer or similar vehicle. The height can be in a range of, for example, from 6 feet to 10 feet or any sub range located therein (e.g., from 7 feet to 8.5 feet).

The width of the charging station 100 can be sufficient such that an electric passenger vehicle can fit within the main body structure 105. For example, the width of the charging station 100 can be at least 6.5 feet, at least 7 feet, at least 7.5 feet, at least 8 feet, at least 8.5 feet, at least 9 feet, at least 9 feet and 2 inches, at least 9.5 feet, at least 10 feet, or at least 10.5 feet. The width can also be small enough such that the overall charging station 100 size is suitable for transport on a tractor trailer or similar vehicle. The width can be in a range of, for example, from 6.5 feet to 11 feet or any sub range located therein (e.g., from 7 feet to 10 feet).

The charging station 100 can be configured to raise and lower the upper level platforms 130,140 from/to the lower level 150, as well as to move any platform present in a lower level space 110,120 fore and aft within the lower level 150, thereby allowing all passenger vehicles to load/unload to/from the charging station 100 independently of any other passenger vehicles on the charging station 100 (see also, e.g., FIGS. 7-10). For example, a cable lift system can be used for raising and lowering the upper level platforms 130,140 from/to the lower level 150, and/or for moving any platform present in a lower level space 110,120 fore and aft within the lower level 150. The tracking of the lower level spaces 110,120 can also be accomplished through any other suitable means in the art for moving a platform fore and aft (e.g., by having any lower level platform on a rail and using electrical and/or mechanical means to move any platform along the rail).

At least one of the upper level platforms 130,140 can be a charging platform configured to charge (e.g., wirelessly or in a wired fashion) an electric passenger vehicle while it is on the respective platform. The lower level platforms 110,120 can be configured to charge (e.g., wirelessly or in a wired fashion) an electric passenger vehicle while it is on the respective platform. In some embodiments, one or more of the lower level platforms is not configured for charging and/or may not include a platform and just be a space to allow for fore and aft tracking of one or more platforms on the lower level.

The main body structure 105 can be made of any suitable material known in the art. For example, the main body structure 105 can be made of steel or other metal (e.g., titanium, etc.), concrete, or (strong) plastic. The main body structure 105 can include two side walls that may optionally each have a large gap therein through which vehicles on the lower level 150 can be seen from outside the charging station 100 (e.g., as seen in FIGS. 1-10). The main body structure 105 can include one or more lateral structures connecting the side walls to each other. The main body structure 105 can include cables, rails, and/or other structures that can be used to move platforms fore and aft on the lower level and/or raise platforms from the lower level to the upper level and/or lower platforms from the upper level to the lower level.

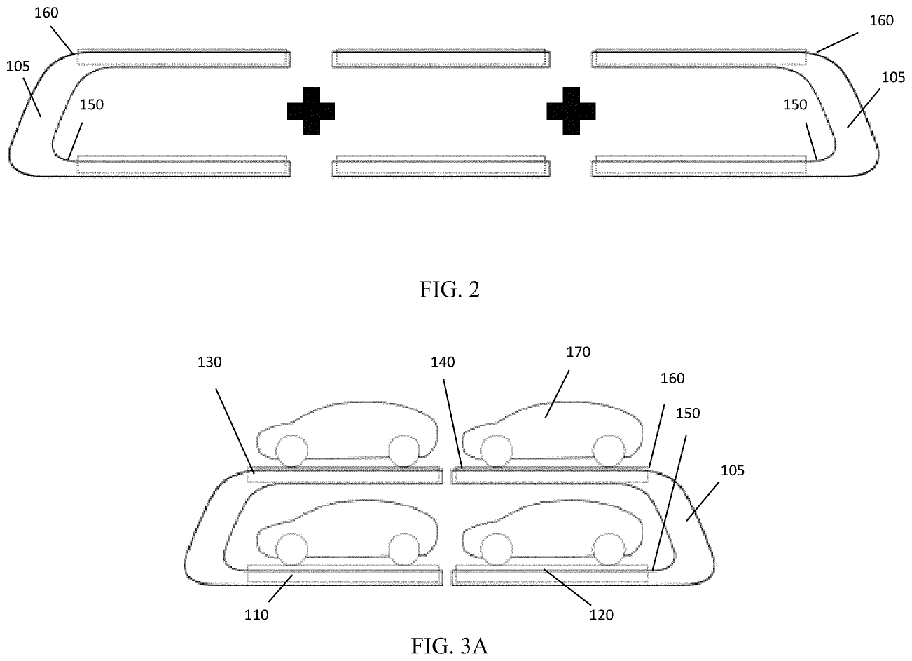

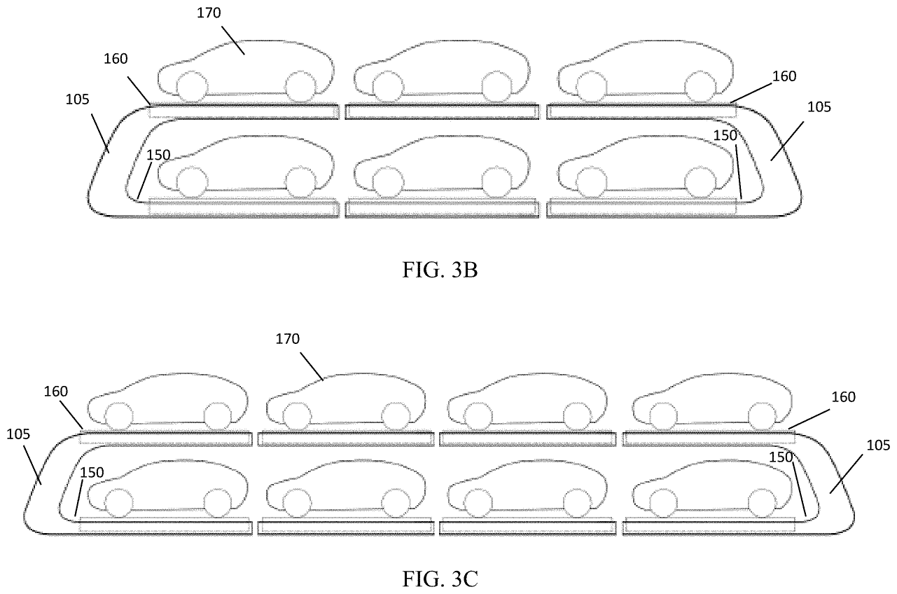

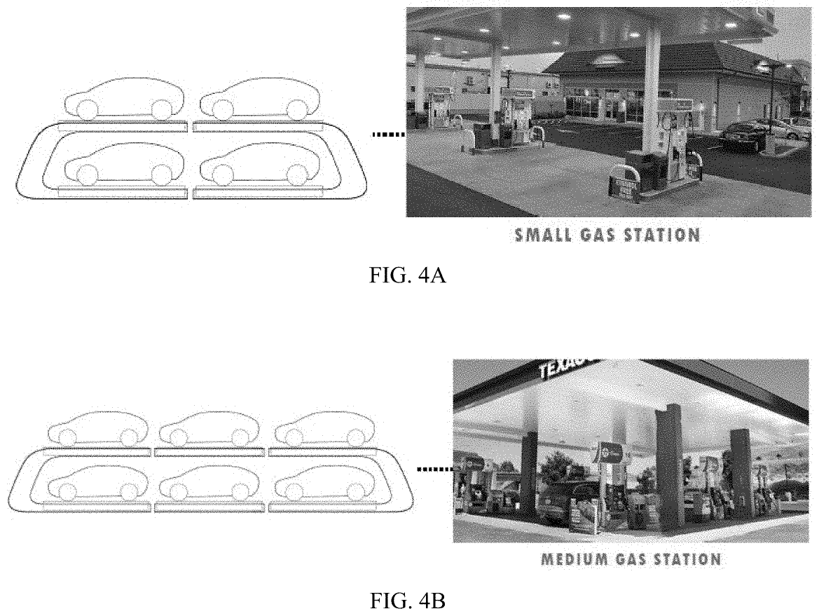

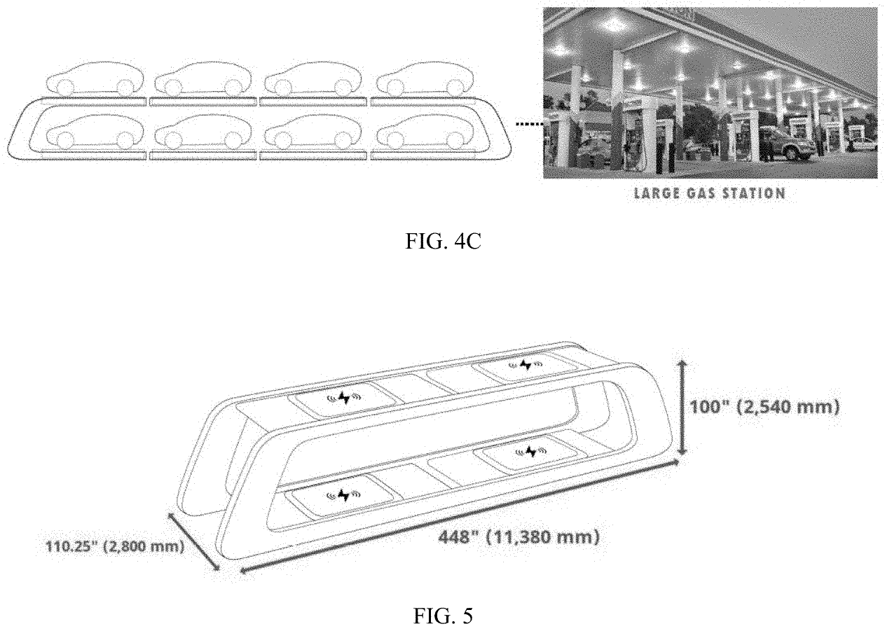

The concept of the charging station 100 shown in FIG. 1 can be extended to make longer charging stations, as depicted in FIG. 2, by adding additional spaces/platforms to the upper 160 and lower 150 levels. FIGS. 3A, 3B, and 3C show embodiments of charging stations with four spaces (two on each level), six spaces (three on each level), and eight spaces (four on each level), respectively. The charging stations of FIGS. 3A, 3B, and 3C can hold up to four passenger vehicles 170, six passenger vehicles 170, and eight passenger vehicles 170, respectively. FIGS. 4A, 4B, and 4C illustrate that the stations of FIGS. 3A, 3B, and 3C may be appropriate for a small-sized gas station, a medium-sized gas station, and a large-sized gas station, respectively. Though, the depictions in FIGS. 4A-4C are for exemplary purposes only and should not be construed as limiting; a larger charging station may be used at a small-sized gas station, a larger or smaller charging station may be used at a medium-sized gas station, and a larger or smaller charging station may be used at a large-sized gas station.

The length of the charging station 100 can be sufficient such that at least two electric passenger vehicles can fit on the upper level 160. For example, the length of the charging station 100 can be at least 30 feet, at least 31 feet, at least 32 feet, at least 33 feet, at least 34 feet, at least 35 feet, at least 36 feet, at least 37 feet, at least 37 feet and 4 inches, at least 38 feet, at least 39 feet, at least 40 feet, or more. The length can also be small enough such that the overall charging station 100 size is suitable for transport on a tractor trailer or similar vehicle. The length will of course be longer for charging stations designed to fit more passenger vehicles 170 (e.g., as shown in FIGS. 3B and 3C). The length can be in a range of, for example, from 30 feet to 108 feet or any sub range located therein (e.g., from 35 feet to 75 feet).

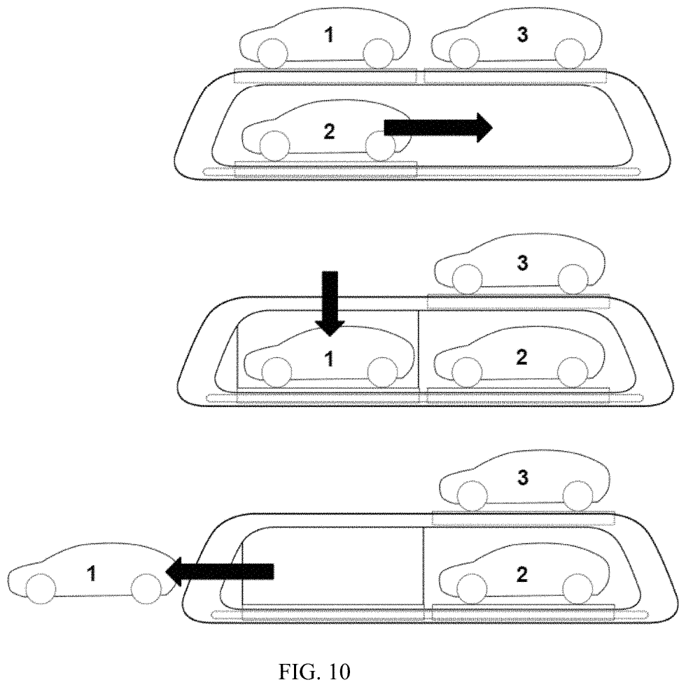

FIGS. 7-10 illustrate how a first passenger vehicle (labeled “2” in FIG. 10) may be tracked on the lower level and a second passenger vehicle (labeled “1” in FIG. 10) may be lowered from the upper level (e.g., after charging) to thereby exit the charging station. Referring to FIGS. 7-10, the lower level platform having the first passenger vehicle can be moved aft to free up the lower level space below the second passenger vehicle. The upper level platform having the second passenger vehicle can then be lowered to the free space, allowing the second passenger vehicle to exit the charging station by driving forward out of the main body structure. The platform on which the second passenger vehicle was on can then be raised (e.g., to be kept in the upper level and/or to allow the third passenger vehicle (labeled “3” in FIG. 10) on the upper level to drive onto it (e.g., if it is the only platform with charging capabilities)), kept in place to allow the first passenger vehicle to drive onto it (e.g., if it has charging capabilities and the platform on which the first passenger vehicle is currently disposed does not), or remain in place to await another passenger vehicle.

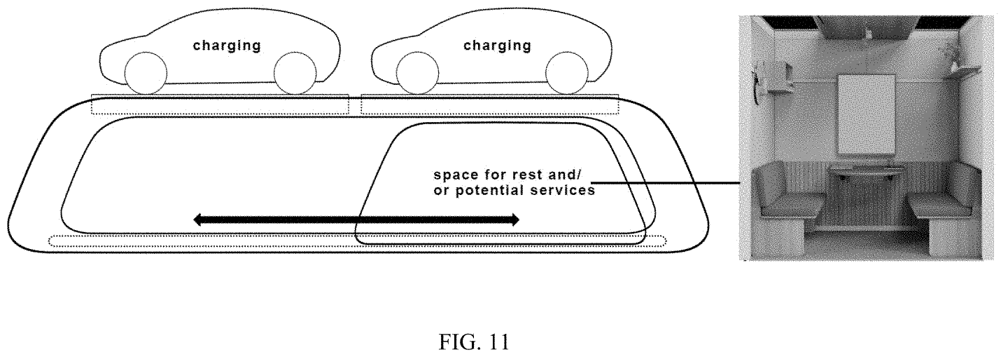

FIG. 11 shows a perspective view of a charging station, according to an embodiment of the subject invention, in which the lower level may include a space for rest and/or services in one of the lower level spaces (instead of a space for a passenger vehicle). Referring to FIG. 11, the charging station can include a semi-enclosed or completely enclosed space where owners of the passenger vehicles may rest and/or purchase services while the passenger vehicles are charging. This space can be similar to a convenience store on a smaller scale and/or can be similar to a small seating area as depicted in the right-hand side of FIG. 11.

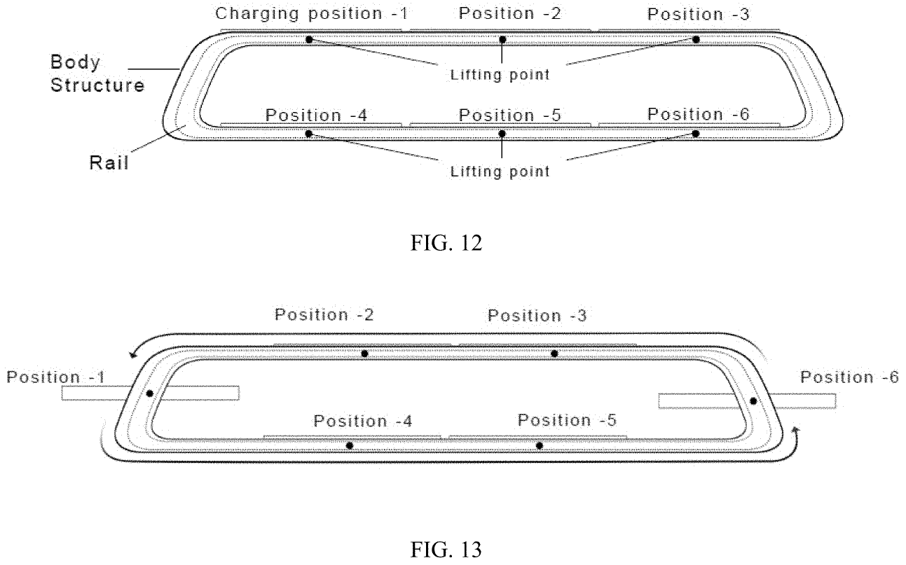

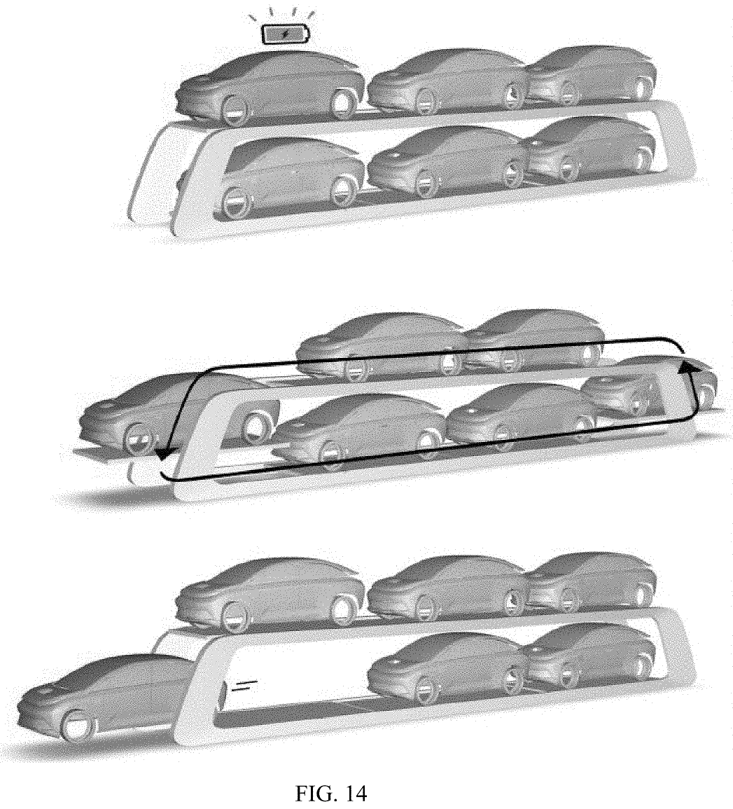

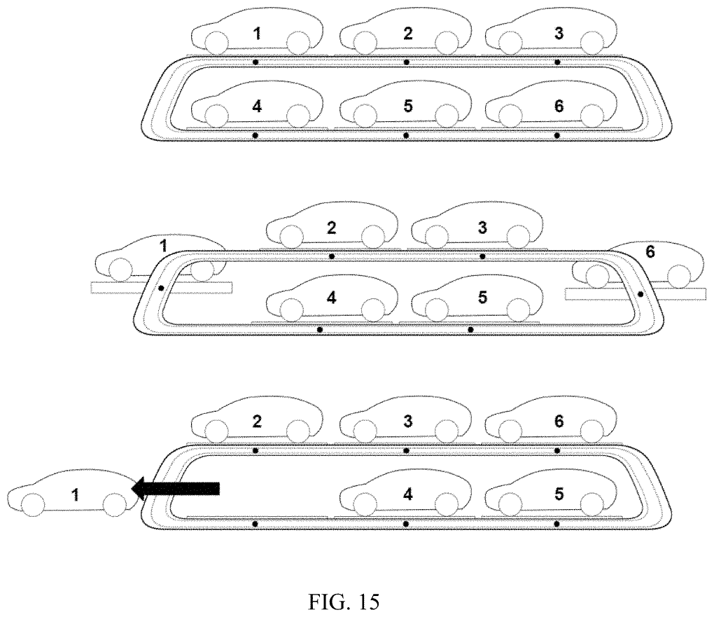

FIGS. 12 and 13 show perspective views of a charging station, according to another embodiment of the subject invention, in which the spaces or positions can be rotated around the main body structure. Referring to FIGS. 12 and 13, the charging station can utilize a single axis lift system that moves along a rotating carousel track, moving all vehicle spaces/platforms around the main body structure to allow passenger vehicles to be loaded and/or unloaded without moving other passenger vehicles from their respective spaces/platforms (e.g., without disconnecting the other passenger vehicles from the wireless/wired charging if they are being charged currently on the platform/spaces. FIGS. 14 and 15 illustrate how a passenger vehicle (labeled “1” in FIG. 15) can be moved from the upper level to the lower level to be able to exit the charging station. All of the platforms can rotate (in a counter-clockwise direction, as depicted in FIGS. 14 and 15), allowing a passenger vehicle from the opposite side on the lower level (labeled “6” in FIG. 15) to move from the lower level to the upper level and allowing the passenger vehicle from the upper level to move to the lower level so it can exit the charging station without requiring any of the other passenger vehicles to move from their respective platforms. A waiting passenger vehicle can then pull into the vacated platform spot and begin charging. As the passenger vehicles charge, they move around the charging station, moving to the upper level and then eventually returning to the lower level to exit after charging. Also, any vehicle can be moved from the upper level (or the middle lower level platform) at any time to an exit location (the outside lower level platforms) if it finishes charging while in one of the non-exit locations (upper level or middle lower level). In addition, the charging station of this embodiment can have a space for rest and/or services in one of the spaces (as shown in FIG. 11). Also, the height, width, and length dimensions of this embodiment can be within the ranges disclosed for the embodiment shown in FIGS. 1-4C. In addition, the charging station can also rotate in the opposite direction (e.g., clockwise as depicted in FIGS. 14 and 15), which would allow the vehicle labeled “3” in FIG. 15 to move to the lower level and back out.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

When ranges are used herein, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

The methods, systems, and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals (i.e., computer-readable media can be referred to as non-transitory). A computer-readable medium of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

The subject invention includes, but is not limited to, the following exemplified embodiments.

Embodiment 1. A charging station for charging electric passenger vehicles, the charging station comprising:

a main body structure comprising a first side wall and a second side wall spaced apart from the first side wall, the main body structure comprising a lower level and an upper level;

a first platform disposed between the first side wall and the second side wall and configured to support a first electric passenger vehicle parked thereon and to charge the first electric passenger vehicle;

a second platform disposed between the first side wall and the second side wall and configured to support a second electric passenger vehicle parked thereon; and

a third platform disposed between the first side wall and the second side wall and configured to support a third electric passenger vehicle parked thereon,

wherein the charging station is configured such that each of the first platform, the second platform, and the third platform is movable from the upper level to the lower level and back.

Embodiment 2. The charging station according to embodiment 1, wherein the first platform is configured to wirelessly charge the first electric passenger vehicle while the first electric passenger vehicle is parked on the first platform.

Embodiment 3. The charging station according to embodiment 1, wherein the first platform is configured to charge the first electric passenger vehicle using a first charging cord or wire while the first electric passenger vehicle is parked on the first platform.

Embodiment 4. The charging station according to any of embodiments 1-3, wherein the second platform is configured to charge the second electric passenger vehicle while the second electric passenger vehicle is parked on the second platform.

Embodiment 5. The charging station according to embodiment 4, wherein the second platform is configured to wirelessly charge the second electric passenger vehicle while the second electric passenger vehicle is parked on the second platform.

Embodiment 6. The charging station according to embodiment 4, wherein the second platform is configured to charge the second electric passenger vehicle using a second charging cord or wire while the second electric passenger vehicle is parked on the second platform.

Embodiment 7. The charging station according to any of embodiments 1-6, wherein the third platform is configured to charge the third electric passenger vehicle while the third electric passenger vehicle is parked on the third platform.

Embodiment 8. The charging station according to embodiment 7, wherein the third platform is configured to wirelessly charge the third electric passenger vehicle while the third electric passenger vehicle is parked on the third platform.

Embodiment 9. The charging station according to embodiment 7, wherein the third platform is configured to charge the third electric passenger vehicle using a third charging cord or wire while the third electric passenger vehicle is parked on the third platform.

Embodiment 10. The charging station according to any of embodiments 1-9, further comprising a fourth platform disposed between the first side wall and the second side wall and configured to support a fourth electric passenger vehicle parked thereon,

wherein the charging station is configured such that the fourth platform is movable from the upper level to the lower level and back.

Embodiment 11. The charging station according to embodiment 10, wherein the fourth platform is configured to charge the fourth electric passenger vehicle while the fourth electric passenger vehicle is parked on the fourth platform.

Embodiment 12. The charging station according to embodiment 11, wherein the fourth platform is configured to wirelessly charge the fourth electric passenger vehicle while the fourth electric passenger vehicle is parked on the fourth platform.

Embodiment 13. The charging station according to embodiment 11, wherein the fourth platform is configured to charge the fourth electric passenger vehicle using a fourth charging cord or wire while the fourth electric passenger vehicle is parked on the fourth platform.

Embodiment 14. The charging station according to any of embodiments 1-13, further comprising a fifth platform disposed between the first side wall and the second side wall and configured to support a fifth electric passenger vehicle parked thereon,

wherein the charging station is configured such that the fifth platform is movable from the upper level to the lower level and back.

Embodiment 15. The charging station according to embodiment 14, wherein the fifth platform is configured to charge the fifth electric passenger vehicle while the fifth electric passenger vehicle is parked on the fifth platform.

Embodiment 16. The charging station according to embodiment 15, wherein the fifth platform is configured to wirelessly charge the fifth electric passenger vehicle while the fifth electric passenger vehicle is parked on the fifth platform.

Embodiment 17. The charging station according to embodiment 15, wherein the fifth platform is configured to charge the fifth electric passenger vehicle using a fifth charging cord or wire while the fifth electric passenger vehicle is parked on the fifth platform.

Embodiment 18. The charging station according to any of embodiments 1-17, further comprising a sixth platform disposed between the first side wall and the second side wall and configured to support a sixth electric passenger vehicle parked thereon,

wherein the charging station is configured such that the sixth platform is movable from the upper level to the lower level and back.

Embodiment 19. The charging station according to embodiment 18, wherein the sixth platform is configured to charge the sixth electric passenger vehicle while the sixth electric passenger vehicle is parked on the sixth platform.

Embodiment 20. The charging station according to embodiment 19, wherein the sixth platform is configured to wirelessly charge the sixth electric passenger vehicle while the sixth electric passenger vehicle is parked on the sixth platform.

Embodiment 21. The charging station according to embodiment 19, wherein the sixth platform is configured to charge the sixth electric passenger vehicle using a sixth charging cord or wire while the sixth electric passenger vehicle is parked on the sixth platform.

Embodiment 22. The charging station according to any of embodiments 1-21, further comprising a seventh platform disposed between the first side wall and the second side wall and configured to support a seventh electric passenger vehicle parked thereon,

wherein the charging station is configured such that the seventh platform is movable from the upper level to the lower level and back.

Embodiment 23. The charging station according to embodiment 22, wherein the seventh platform is configured to charge the seventh electric passenger vehicle while the seventh electric passenger vehicle is parked on the seventh platform.

Embodiment 24. The charging station according to embodiment 23, wherein the seventh platform is configured to wirelessly charge the seventh electric passenger vehicle while the seventh electric passenger vehicle is parked on the seventh platform.

Embodiment 25. The charging station according to embodiment 23, wherein the seventh platform is configured to charge the seventh electric passenger vehicle using a seventh charging cord or wire while the seventh electric passenger vehicle is parked on the seventh platform.

Embodiment 26. The charging station according to any of embodiments 1-25, further comprising an eighth platform disposed between the first side wall and the second side wall and configured to support a eighth electric passenger vehicle parked thereon,

wherein the charging station is configured such that the eighth platform is movable from the upper level to the lower level and back.

Embodiment 27. The charging station according to embodiment 26, wherein the eighth platform is configured to charge the eighth electric passenger vehicle while the eighth electric passenger vehicle is parked on the eighth platform.

Embodiment 28. The charging station according to embodiment 27, wherein the eighth platform is configured to wirelessly charge the eighth electric passenger vehicle while the eighth electric passenger vehicle is parked on the eighth platform.

Embodiment 29. The charging station according to embodiment 27, wherein the eighth platform is configured to charge the eighth electric passenger vehicle using a eighth charging cord or wire while the eighth electric passenger vehicle is parked on the eighth platform.

Embodiment 30. The charging station according to any of embodiments 1-29, wherein a height of the lower level (a distance between the upper surface of the lower level spaces and the lower surface of the upper level platforms) is in a range of from 7 feet to 8.5 feet (e.g., from 8 feet to 8.5 feet).

Embodiment 31. The charging station according to any of embodiments 1-30, wherein a width of the charging station is in a range of from 7 feet to 10 feet (e.g., from 8 feet to 9.5 feet).

Embodiment 32. The charging station according to any of embodiments 1-31, wherein a length of the charging station is in a range of from 30 feet to 108 feet (e.g., from 35 feet to 75 feet or from 35 feet to 55 feet or from 35 feet to 40 feet).

Embodiment 33. The charging station according to any of embodiments 1-32, wherein the charging station is mobile (e.g., capable of being transported by a tractor trailer or similar transport vehicle).

Embodiment 34. The charging station according to any of embodiments 1-33, wherein the charging station is configured such that each of the first platform, the second platform, and the third platform (and the fourth, fifth, sixth, seventh, and/or eight platform (if present)) is independently movable fore and aft within the lower level.

Embodiment 35. The charging station according to embodiment 34, wherein the charging station is configured such that each of the first platform, the second platform, and the third platform (and the fourth, fifth, sixth, seventh, and/or eight platform (if present)) is independently movable fore and aft within the lower level by using a rail on the lower level.

Embodiment 36. The charging station according to any of embodiments 1-35, wherein the charging station is configured such that each of the first platform, the second platform, and the third platform (and the fourth, fifth, sixth, seventh, and/or eight platform (if present)) is movable from the upper level to the lower level and back by using a cable lift system.

Embodiment 37. The charging station according to any of embodiments 1-36, wherein the charging station is configured such that each of the first platform, the second platform, and the third platform (and the fourth, fifth, sixth, seventh, and/or eight platform (if present)) is independently movable from the upper level to the lower level and back.

Embodiment 38. The charging station according to any of embodiments 1-37, wherein the charging station is configured such that each of the first platform, the second platform, and the third platform (and the fourth, fifth, sixth, seventh, and/or eight platform (if present)) is independently movable from the upper level to the lower level and back by using a cable lift system.

Embodiment 39. The charging station according to any of embodiments 1-38, further comprising a (semi-enclosed or fully enclosed) structure disposed on one of the second platform and the third platform and being configured to provide rest and/or services to a driver of an electric passenger vehicle being charged on the charging station.

Embodiment 40. The charging station according to any of embodiments 1-39, wherein the charging station is configured to rotate (carousel-style) each of the first platform, the second platform, and the third platform (and the fourth, fifth, sixth, seventh, and/or eight platform (if present)) around the main body structure, such that when one platform is lowered from the upper level to the lower level at a proximal end of the main body structure, another platform is simultaneously raised from the lower level to the upper level at a distal end of the main body structure opposite from the proximal end (see, e.g., FIGS. 12-15).

Embodiment 41. The charging station according to embodiment 40, wherein the charging station is configured to rotate (carousel-style) each of the first platform, the second platform, and the third platform (and the fourth, fifth, sixth, seventh, and/or eight platform (if present)) around the main body structure using a cable system.

Embodiment 42. The charging station according to any of embodiments 40-41, wherein the charging station comprises the first platform, the second platform, the third platform, the fourth platform, the fifth platform, and the sixth platform (see, e.g., FIGS. 12-15).

Embodiment 43. The charging station according to any of embodiments 1-42, wherein each of the first side wall and the second side wall has a longer length at the lower level than it does at the upper level.

Embodiment 44. The charging station according to any of embodiments 1-43, wherein the main body structure comprises metal (e.g., steel, titanium, etc.), concrete, and/or (strong) plastic.

Embodiment 45. A method of charging an electric passenger vehicle, the method comprising:

parking the electric passenger vehicle on a platform (e.g., the first platform, the second platform, the third platform, the fourth, fifth, sixth, seventh, or eighth (if present) platform) of the charging station according to any of embodiments 1-44, the platform being configured to charge the electric passenger vehicle while it is parked thereon;

allowing the electric passenger vehicle to charge; and

exiting the charging station after the electric passenger vehicle has been charged.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A charging station for charging electric passenger vehicles, the charging station comprising:
a main body structure comprising a first side wall and a second side wall spaced apart from the first side wall, the main body structure comprising a lower level and an upper level;
a first platform disposed between the first side wall and the second side wall and configured to support a first electric passenger vehicle parked thereon and to charge the first electric passenger vehicle;
a second platform disposed between the first side wall and the second side wall and configured to support a second electric passenger vehicle parked thereon; and
a third platform disposed between the first side wall and the second side wall and configured to support a third electric passenger vehicle parked thereon,
wherein the charging station is configured such that each of the first platform, the second platform, and the third platform is movable from the upper level to the lower level and back.

2. The charging station according to claim 1, wherein the first platform is configured to wirelessly charge the first electric passenger vehicle while the first electric passenger vehicle is parked on the first platform.

3. The charging station according to claim 1, wherein the second platform is configured to wirelessly charge the second electric passenger vehicle while the second electric passenger vehicle is parked on the second platform.

4. The charging station according to claim 1, wherein the third platform is configured to wirelessly charge the third electric passenger vehicle while the third electric passenger vehicle is parked on the third platform.

5. The charging station according to claim 1, further comprising a fourth platform disposed between the first side wall and the second side wall and configured to support a fourth electric passenger vehicle parked thereon,
wherein the charging station is configured such that the fourth platform is movable from the upper level to the lower level and back, and
wherein the fourth platform is configured to wirelessly charge the fourth electric passenger vehicle while the fourth electric passenger vehicle is parked on the fourth platform.

6. The charging station according to claim 1, wherein a height of the lower level is in a range of from 7 feet to 8.5 feet.

7. The charging station according to claim 1, wherein a width of the charging station is in a range of from 7 feet to 10 feet.

8. The charging station according to claim 1, wherein a length of the charging station is in a range of from 35 feet to 40 feet.

9. The charging station according to claim 1, wherein the charging station is mobile.

10. The charging station according to claim 1, wherein the charging station is configured such that each of the first platform, the second platform, and the third platform is independently movable fore and aft within the lower level, and
wherein the charging station is configured such that each of the first platform, the second platform, and the third platform is independently movable from the upper level to the lower level and back.

11. The charging station according to claim 10, wherein the charging station is configured such that each of the first platform, the second platform, and the third platform is independently movable fore and aft within the lower level by using a rail on the lower level.

12. The charging station according to claim 10, wherein the charging station is configured such that each of the first platform, the second platform, and the third platform is independently movable from the upper level to the lower level and back by using a cable lift system

13. The charging station according to claim 1, further comprising a semi-enclosed or fully enclosed structure disposed on one of the second platform and the third platform and being configured to provide rest, services, or both to a driver of an electric passenger vehicle being charged on the charging station.

14. The charging station according to claim 1, wherein each of the first side wall and the second side wall has a longer length at the lower level than it does at the upper level.

15. The charging station according to claim 1, further comprising a fourth platform disposed between the first side wall and the second side wall and configured to support a fourth electric passenger vehicle parked thereon,
wherein the charging station is configured such that the fourth platform is movable from the upper level to the lower level and back, and
wherein the fourth platform is configured to wirelessly charge the fourth electric passenger vehicle while the fourth electric passenger vehicle is parked on the fourth platform,
wherein the charging station is configured to rotate in a carousel style each of the first platform, the second platform, the third platform, and the fourth platform around the main body structure, such that when one platform of the first platform, the second platform, the third platform, and the fourth platform is lowered from the upper level to the lower level at a proximal end of the main body structure, another platform of the first platform, the second platform, the third platform, and the fourth platform is simultaneously raised from the lower level to the upper level at a distal end of the main body structure opposite from the proximal end.

16. The charging station according to claim 15, wherein the charging station is configured to rotate in a carousel style each of the first platform, the second platform, the third platform, and the fourth platform around the main body structure using a cable system.

17. The charging station according to claim 1, further comprising:
a fourth platform disposed between the first side wall and the second side wall and configured to support a fourth electric passenger vehicle parked thereon;
a fifth platform disposed between the first side wall and the second side wall and configured to support a fifth electric passenger vehicle parked thereon; and
a sixth platform disposed between the first side wall and the second side wall and configured to support a sixth electric passenger vehicle parked thereon,
wherein the charging station is configured such that the fourth platform is movable from the upper level to the lower level and back,
wherein the fourth platform is configured to wirelessly charge the fourth electric passenger vehicle while the fourth electric passenger vehicle is parked on the fourth platform,
wherein the charging station is configured such that the fifth platform is movable from the upper level to the lower level and back,
wherein the fifth platform is configured to wirelessly charge the fifth electric passenger vehicle while the fifth electric passenger vehicle is parked on the fifth platform,
wherein the charging station is configured such that the sixth platform is movable from the upper level to the lower level and back,
wherein the sixth platform is configured to wirelessly charge the sixth electric passenger vehicle while the sixth electric passenger vehicle is parked on the sixth platform,
wherein the charging station is configured to rotate in a carousel style each of the first platform, the second platform, the third platform, the fourth platform, the fifth platform, and the sixth platform around the main body structure, such that when one platform of the first platform, the second platform, the third platform, the fourth platform, the fifth platform, and the sixth platform is lowered from the upper level to the lower level at a proximal end of the main body structure, another platform of the first platform, the second platform, the third platform, the fourth platform, the fifth platform, and the sixth platform is simultaneously raised from the lower level to the upper level at a distal end of the main body structure opposite from the proximal end.

18. The charging station according to claim 17, wherein the charging station is configured to rotate in a carousel style each of the first platform, the second platform, the third platform, the fourth platform, the fifth platform, and the sixth platform around the main body structure using a cable system.

19. The charging station according to claim 18, wherein the first platform is configured to wirelessly charge the first electric passenger vehicle while the first electric passenger vehicle is parked on the first platform,
wherein the second platform is configured to wirelessly charge the second electric passenger vehicle while the second electric passenger vehicle is parked on the second platform,
wherein the third platform is configured to wirelessly charge the third electric passenger vehicle while the third electric passenger vehicle is parked on the third platform,
wherein a height of the lower level is in a range of from 7 feet to 8.5 feet,
wherein a width of the charging station is in a range of from 7 feet to 10 feet,
wherein a length of the charging station is in a range of from 50 feet to 60 feet,
wherein the charging station is mobile, and
wherein each of the first side wall and the second side wall has a longer length at the lower level than it does at the upper level.

20. A charging station for charging electric passenger vehicles, the charging station comprising:
a main body structure comprising a first side wall and a second side wall spaced apart from the first side wall, the main body structure comprising a lower level and an upper level;
a first platform disposed between the first side wall and the second side wall and configured to support a first electric passenger vehicle parked thereon and to charge the first electric passenger vehicle;
a second platform disposed between the first side wall and the second side wall and configured to support a second electric passenger vehicle parked thereon;
a third platform disposed between the first side wall and the second side wall and configured to support a third electric passenger vehicle parked thereon;
a fourth platform disposed between the first side wall and the second side wall and configured to support a fourth electric passenger vehicle parked thereon; and
a semi-enclosed or fully enclosed structure disposed on the fourth platform and being configured to provide rest, services, or both to a driver of an electric passenger vehicle being charged on the charging station,
wherein the charging station is configured such that each of the first platform, the second platform, the third platform, and the fourth platform is independently movable from the upper level to the lower level and back by using a cable lift system,
wherein the first platform is configured to wirelessly charge the first electric passenger vehicle while the first electric passenger vehicle is parked on the first platform,
wherein the second platform is configured to wirelessly charge the second electric passenger vehicle while the second electric passenger vehicle is parked on the second platform,
wherein the third platform is configured to wirelessly charge the third electric passenger vehicle while the third electric passenger vehicle is parked on the third platform,
wherein a height of the lower level is in a range of from 7 feet to 8.5 feet,
wherein a width of the charging station is in a range of from 7 feet to 10 feet,
wherein a length of the charging station is in a range of from 35 feet to 40 feet,
wherein the charging station is mobile, and
wherein each of the first side wall and the second side wall has a longer length at the lower level than it does at the upper level.
